(19) United States
(12) Patent Application Publication
(10) Pub. No.: US 2022/0147636 A1
(43) Pub. Date: May 12, 2022

(54) ZERO-TOUCH SECURITY SENSOR UPDATES

(71) Applicant: CrowdStrike, Inc., Irvine, CA (US)

(72) Inventors: Harsha Mahuli, Sammamish, WA (US); Cat S. Zimmermann, Seattle, WA (US)

(21) Appl. No.: 17/095,884

(22) Filed: Nov. 12, 2020

(51) Int. Cl. G06F 21/57; G06F 8/65

(52) U.S. Cl. CPC G06F 21/577; G06F 2221/034; G06F 8/65

(57) ABSTRACT

A system for updating a security sensor monitoring potential security threats on an endpoint computing device includes is configured to access an updated version of the computing environment running on the end-point computing device. The system builds an updated security sensor based at least in part on the updated version of the computing environment. The system determines compatibility of the updated security sensor with an earlier-version of the computing environment by comparing the updated security sensor with an earlier version of the security sensor that was built for the earlier-version computing environment. The system communicates an indication of the compatibility to the end-point computing device.

### BACKGROUND

Digital security exploits that steal or destroy resources, data, and private information on computing devices are an increasing problem. Governments and businesses devote significant resources to preventing intrusions and thefts related to such digital security exploits. Some of the threats posed by security exploits are of such significance that they are described as cyber terrorism or industrial espionage.

Security threats come in many forms, including computer viruses, worms, trojan horses, spyware, keystroke loggers, adware, and rootkits. Such security threats may be delivered in or through a variety of mechanisms, such as spearfish emails, clickable links, documents, executables, or archives. Other types of security threats may be posed by malicious users who gain access to a computer system and attempt to access, modify, or delete information without authorization.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts an example of a digital security system.

FIG. 2 depicts segmentation of a security sensor binary.

FIG. 3 depicts an example of a segment-by-segment comparison process of security senor binaries performed by a security service system.

FIG. 4 depicts a flowchart of operations that can be performed by an instance of a security service system.

FIG. 5 depicts a flowchart of operations that can be performed by an instance of a security service system.

FIG. 6 depicts a flowchart of operations that can be performed by an instance of a security sensor.

FIG. 7 depicts an example system architecture for an endpoint device.

FIG. 8 depicts an example system architecture for a security service system.

### DETAILED DESCRIPTION

Events can occur on computer systems that may be indicative of security threats or exploits to those systems. While in some cases a single event may be enough to trigger detection of a security threat, in other cases individual events may be innocuous on their own but be indicative of a security threat when considered in combination. For instance, the acts of opening a file, copying file contents, and opening a network connection to an Internet Protocol (IP) address may each be normal and/or routine events on a computing device when each act is considered alone, but the combination of the acts may indicate that a process is attempting to steal information from a file and send it to a server.

Digital security systems have accordingly been developed that can observe events occurring on a computing device and use data about those events to detect and/or analyze security threats. In some digital security systems, a security agent or security sensor is deployed to an endpoint computing device (e.g., a server, personal computer, mobile computing device) that interfaces with the computing environment of the endpoint device to detect events. The security sensor may take actions based on detected events and/or report detected events back to a distributed, networked, or cloud-based service to act based on the events, if needed.

Digital security systems may focus event detection at the user-space level (e.g., events related to detecting user actions) and/or at the computing platform or environment level (e.g., events related to an operating system events or events related to hardware and software drivers). Event detection at the computing platform level may include detecting events related to the operating system kernel executing at the endpoint computing system.

Computing platforms and operating systems may have several variations, and updates may occur frequently. As just one example, the Linux operating system has many different implementations or distributions (e.g., Red Hat, Mandrake, Ubunutu, Fedora, Debian), each having customizations or modifications to the operating system kernel. For each of these implementations, the digital security system service may provide a security sensor. Since the security sensor is tightly coupled with the computing platform, each computing platform implementation has a corresponding security sensor implementation tailored for the platform implementation. When there are changes to the computing platform and/or operating system kernel, the digital security system service may need to build an updated security sensor and distribute it the endpoint devices the digital security system service supports.

To ensure proper operation with the computing platform and/or operating system kernel, security sensors can be configured to enter a reduced functionality mode (RFM). While in RFM, the security sensor can perform basic operations such as communicating with the digital security system service to receive updates or configurations, but security sensors may not perform event detection or take security actions based on detected events indicating a security breach. In some implementations, the security sensor can detect updates to the computing platform and/or operating system kernel and enter RFM when it detects an update and remain in that mode until the security sensor has been updated to be compatible with the update to the computing platform and/or operating system kernel.

While having the security sensor in RFM after detection of an update to the computing platform and/or operating system kernel can be desirable to reduce errors arising from compatibility issues, a security sensor in RFM will not be serving its primary purpose—monitoring events on the endpoint computing system for potential security threats. Traditionally, the security sensor exits RFM when either it is updated to match the updates to the computing platform, or the computing platform and/or operating system kernel is downgraded to a version for which the security sensor is compatible.

While the digital security system service may distribute compatible upgrades to security sensors, such distributions are often on a periodic basis and may leave the endpoint device exposed to security threats in the period between when the security sensor entered RFM and when the digital security system service provides an update that is compatible with the computing platform of the endpoint computing system. Moreover, an update to the security sensor can cause disruption to operation of the endpoint device or require a reboot. In addition, when the digital security system service is supporting a large number of endpoint devices, distributing updated security sensors may require a large amount of bandwidth and network resources to provide security sensors to all endpoints.

The above issues are more problematic in instances where an update to the security sensor may not have been needed. Such instances occur, for example, when the updates to the computing platform and/or operating system kernel are not related to the interaction between the security sensor and the computing platform and/or operating system kernel. In such instances, rebuilding a corresponding security sensor may result in a binary that is the same, or substantially the same, as a previous version rendering a full-scale upgrade of the security sensor unnecessary. Therefore, it is desirable to have a system or method whereby security sensors can exit RFM without a full security sensor update if the security sensor is still compatible with the computing platform and/or operating system kernel following an update.

To address these issues, the embodiments and implementations disclosed herein provide a digital security system service that provides a zero-touch option for security sensors to exit RFM. According to these embodiments and implementations, the digital security system service accesses an update to the computing platform and/or operating system kernel. The digital security system service can then create a new build of a security sensor that is compatible with the updated computing platform and/or operating system kernel. The digital security system service can then perform a compare between the newly built version of the security sensor and the previous version of the security sensor that was compatible with the previous version of the computing platform and/or operating system kernel. In cases where there is no or little difference between the previous version of the security sensor and the updated version of the security sensor, the distributed security system service can send an indication (e.g., a configuration file containing a mapping of compatible security sensor versions with computing platform versions) to supported endpoints. The security sensors at the supported endpoints may then exit RFM when the indication informs the security sensor that it is compatible with the computing platform and/or operating system kernel running at the endpoint.

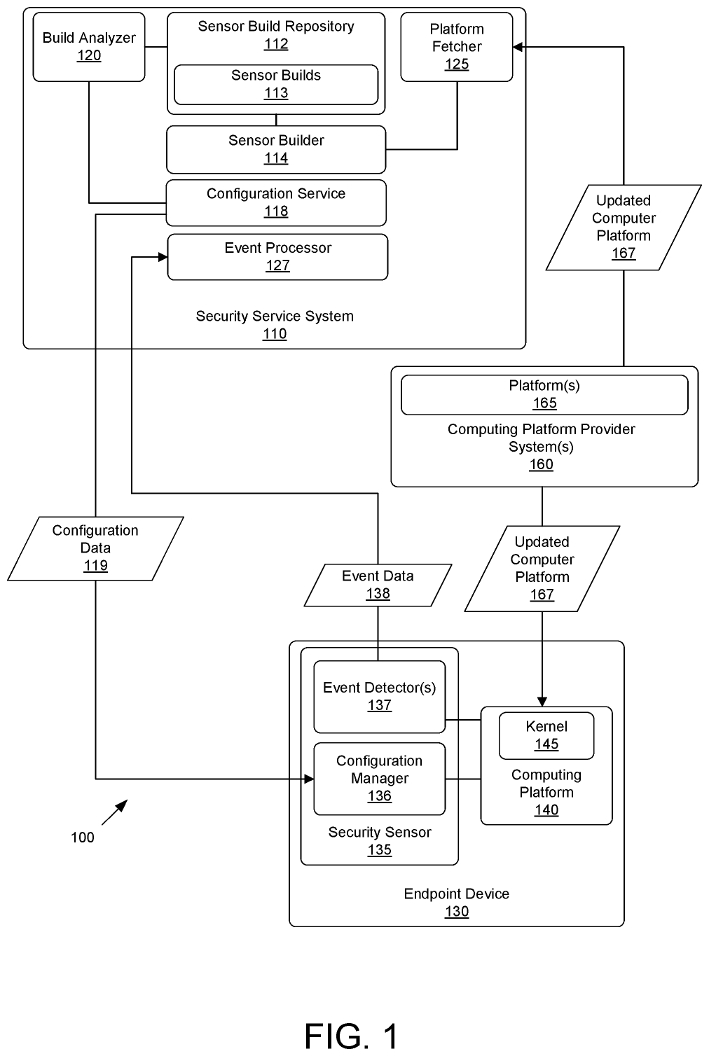

FIG. 1 depicts an example digital security system 100. Digital security system 100 can include security service system 110, endpoint device 130, and computing platform provider system(s) 160. Security service system 110, endpoint device 130, and computing platform provider system(s) 160 can communicate via a network (not shown) which can include one or more local area networks, wide area networks, personal area networks, telephone networks, and/or the Internet, which can be accessed via any available wired and/or wireless communication protocols. Networks using secured and unsecured network communication links are contemplated for use in the systems described herein.

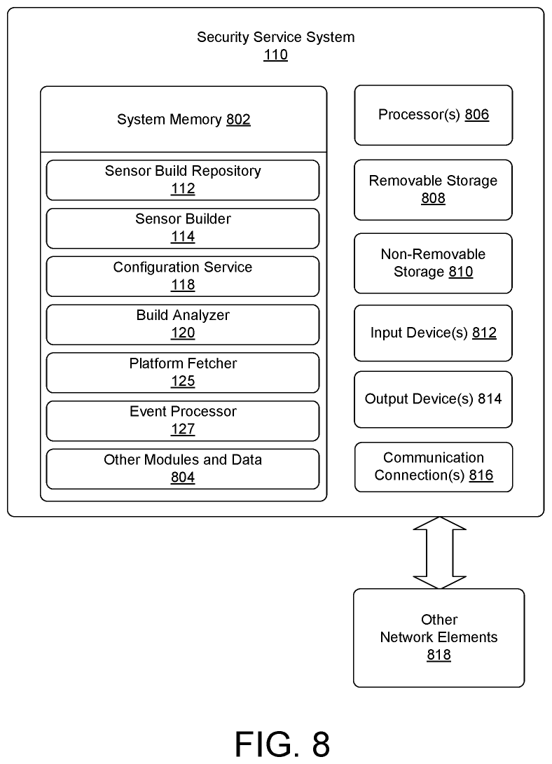

Security service system 110 can include one or more servers, server farms, hardware computing elements, virtualized computing elements, and/or other network computing elements that are remote from endpoint device 130. In some examples, security service system 110 can include a cloud or a cloud computing environment. Endpoint device 130, and/or security sensor 135 executing on such endpoint device 130, can communicate with elements of the security service system 110 through the Internet or other types of network and/or data connections. In some examples, computing elements of security service system 110 can be operated by, or be associated with, an operator of a security service, while endpoint device 130 can be associated with customers, subscribers, and/or other users of the security service. An example system architecture for one or more cloud computing elements, or server computing elements, that can be part of security service system 110 is illustrated in greater detail in FIG. 8 and described in detail below with reference to that figure.

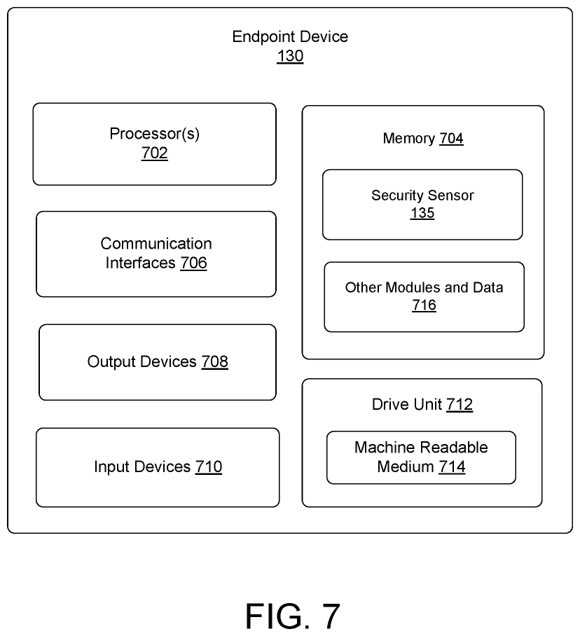

Endpoint device 130 can be, or include, one or more computing devices. In various examples, endpoint device 130 can be a work station, a personal computer (PC), a laptop computer, a tablet computer, a personal digital assistant (PDA), a cellular phone, a media center, an Internet of Things (IoT) device, a server or server farm, multiple distributed server farms, a mainframe, or any other sort of computing device or computing devices. In some examples, endpoint device 130 can be a computing device, component, or system that is embedded or otherwise incorporated into another device or system. In some examples, endpoint device 130 can also be a standalone or embedded component that processes or monitors incoming and/or outgoing data communications. For example, endpoint device 130 can be a network firewall, network router, network monitoring component, a supervisory control and data acquisition (SCADA) component, or any other component. An example system architecture for endpoint device 130 is illustrated in greater detail in FIG. 7 and is described in detail below with reference to that figure.

Computing platform provider systems 160 can include one or more servers, server farms, multiple distributed server farms, a workstation, personal computer, a mainframe, or any other sort of computing device or computing devices. Computing platform provider systems 160 may store and provide platforms 165. Platforms 165 can include computing environments such as operating systems, operating system kernels, firmware, suites of software applications, or other software elements providing an environment for the execution of user applications or services running on various computing devices such as security service system 110 or endpoint device 130, for example. Computing platform provider systems 160 may make available current versions of platforms 165 as well as previous versions. In some embodiments, computing platform provider systems 160 may also provide help forums, user documentation, or other resources.

Security service system 110 can include platform fetcher 125. Platform fetcher 125 can periodically check with computing platform provider systems 160 for updates to computing platforms for which security service system 110 supports security sensors. When platform fetcher 125 detects that a new version of the computing platform is available, it obtains updated computing platform 167 from computing platform provider systems 160.

Security service system 110 can also include sensor builder 114. Sensor builder 114 can compile source code to create security sensors based at least in part upon computing platform versions obtained by platform fetcher 125 from computing platform provider systems 160. When platform fetcher 125 obtains updated computer platform 167 from computing platform provider systems 160, sensor builder 114 can compile and build a security sensor for deployment to endpoint devices 130 having the same version of computing platform as obtained by platform fetcher 125. Sensor builder 114 can store sensor builds 113 in sensor build repository 112 and/or distribute sensor builds 113 to appropriate endpoint devices 130. Sensor builds 113 can be stored as executable libraries or binaries, binary objects, or binary large objects (BLOBs). In some embodiments, sensor builds 113 can be stored as source code or scripts.

Platform fetcher 125 can periodically check computing platform provider systems 160 for updates to platforms 165. When platforms 165 have been updated, platform fetcher can access updated computer platform 167 and provide it to sensor builder 114. Sensor builder 114 can then create a new sensor build 113 corresponding to updated computer platform 167 and store it in sensor build repository 112.

Endpoint device 130 can include computing platform 140. Computing platform 140 can include the computing environment of endpoint device 130 such as the operating system, firmware, a suite of software applications, or other software elements providing an environment for the execution of user applications for services running on endpoint device 130. For example, computing platform 140 can include operating system kernel 145 which facilitates interaction between hardware and software components of endpoint device 130. Kernel 145 can include a Linux kernel, a Windows® kernel, or an XNU (Apple®) operating system kernel, as just some examples.

According to some embodiments, security sensor 135 can be installed on endpoint device 130 and monitor events of computing platform 140 for potentially malicious behavior. Events that occur on endpoint device 130 can be detected or observed by event detectors 137 of security sensor 135. For example, security sensor 135 may execute at a kernel-level and/or as a driver such that the security sensor 135 has visibility into operating system activities from which one or more event detectors 137 of security sensor 135 can observe event occurrences or derive or interpret the occurrences of events. In some examples, security sensor 135 may load at the kernel-level at boot time of endpoint device 130, before or during loading of an operating system. In some examples, security sensor 135 can also, or alternately, have components that operate on a computing device in a user-mode that can detect or observe user actions and/or user-mode events. Examples of kernel-mode and user-mode components of security sensor 135 are described in greater detail in U.S. patent application Ser. No. 13/492,672, entitled “Kernel-Level Security Agent” and filed on Jun. 8, 2012, which issued as U.S. Pat. No. 9,043,903 on May 26, 2015, and is incorporated by reference in its entirety.

When event detector 137 detects or observes a behavior or other event that occurs on endpoint device 130, security sensor 135 can store event data 138 locally on endpoint device 130 and/or transmit event data 128 to event processor 127 of security service system 110. Event processor 127 may perform operations to determine whether event data 138 includes indications of malicious activity occurring on endpoint device 130 or patterns of events that occur on one or more endpoint device 130. In some examples, security sensor 135 can process event data 138 locally.

Events can include any observable and/or detectable type of computing operation, behavior, or other action that may occur on endpoint device 130. For example, events can include events and behaviors associated with Internet Protocol (IP) connections, other network connections, Domain Name System (DNS) requests, operating system functions, file operations, registry changes, process executions, hardware operations, such as virtual or physical hardware configuration changes, and/or any other type of event. By way of non-limiting examples, an event may be that a process opened a file, that a process initiated a DNS request, that a process opened an outbound connection to a certain IP address, that there was an inbound IP connection, that values in an operating system registry were changed, or be any other observable or detectable occurrence on endpoint device 130. In some examples, events based on other such observable or detectable occurrences can be physical and/or hardware events, for instance that a Universal Serial Bus (USB) memory stick or other USB device was inserted or removed, that a network cable was plugged in or unplugged, that a cabinet door or other component of endpoint device 130 was opened or closed, or any other physical or hardware-related event.

According to some embodiments, security sensor 135 can also include configuration manager 136. Configuration manager 136 can receive configuration data 119 from configuration service 118 of security service system 110 and set properties of security sensor 135 to reflect changes that may affect the operation of security sensor 135 as it detects events occurring on endpoint device 130 related to computing platform 140 or kernel 145. Non-limited examples of configuration data can include enabling or disabling certain functionality, providing filters to event detectors 137 to adjust their sensitivity, provide configuration related bug fixes, and/or configure security sensor 135 according to user preferences.

Each security sensor 135 can have a unique identifier, such as an agent identifier (AID). Accordingly, distinct security agents 135 on different endpoint devices 130 can be uniquely identified by other elements of the digital security system 100 using an AID or other unique identifier. In some examples, a security sensor 135 on endpoint device 130 can also be referred to as an agent or security agent.

Since event detector 137 of security sensor 135 monitors events and activity of computing platform 140, security sensor 135 is tightly coupled and dependent upon the version of computing platform 140 and/kernel 145. Stated differently, each version of security sensor 135 is built to operate with a particular version of a computing platform or operating system kernel. As a result, changes to computing platform 140 may result in a need to change security sensor 135.

For example, computing platform provider system 160 may make updated computer platform 167 available to various computing systems—including but not limited to security service system 110 and endpoint device 130—and those computing systems may access computing platform provider systems 160 to obtain updated computer platform 167. Accordingly, endpoint device 130 may update its computing platform 140 by contacting computing platform provider system 160 and accessing updated computer platform 167. Endpoint device 130 may then update its computing platform 140 to updated computing platform 167. But, the update to computing platform 140 may trigger an event detected by event detector 137 which security sensor 135 recognizes as a change that could cause compatibility issues between security sensor 135 and computing platform 140.

To address compatibility issues, security sensor 135 may implement a reduced functionality mode (RFM). In RFM, security sensor 135 can perform routine maintenance tasks and overhead tasks but cannot perform event detection for malware correction activities. For example, security sensor 135 may disable event detectors 137 in RFM, but configuration manager 136 may still be enabled in RFM. So, in some implementations when security sensor 135 receives an event that computing platform 140 has been updated, it can enter RFM to reduce the possibility of compatibility issues causing errors on endpoint device 130 until endpoint device 130 receives an updated security sensor from security service system 110.

In some implementations, security service system 110 provides updates to endpoint device 130 for security sensor 135 on a periodic basis such as every two weeks, once a month, or on demand at the request of endpoint device 130. In some instances, endpoint device 130 may receive updated computer platform 167 and update computing platform 140 to it early in the security sensor update cycle. In such instances, security sensor 135 will enter RFM and remain there for most of the update cycle period until endpoint device 130 receives a corresponding update to security sensor 135. For example, if security service system 110 updates security sensors 135 every fifteen days, and on day two of the fifteen-day update cycle endpoint device 130 updates computing platform 140, security sensor 135 will enter RFM and remain there for thirteen days until security service system 110 provides an update to security sensor 135 corresponding to the newer version of computing platform 140. Because security sensor 135 is in RFM, the functionality of event detectors 137 would be disabled and expose endpoint device 130 to potentially malicious behavior.

To minimize this potential exposure to malicious behavior, build analyzer 120 of security service system 110 may compare security sensors built for updated computing platform 167 with security sensors built for the previous version of the updated computing platform 167. If the compare shows that updated computer platform 167 resulted in no or few changes to security sensor 135, build analyzer 120 may communicate with configuration service 118 to produce configuration data 119 showing an indication that the security sensor built for the previous version of updated computer platform 167 is compatible with updated computer platform 167. Then, security service system 110 can push configuration data 119 to configuration manager 136 of security sensor 135. Since configuration manager 136 remains functional in RFM, configuration manager 136 can analyze configuration data 119, determine it shows that security sensor 135 is compatible with updated computer platform 167, and exit RFM.

To fully update security sensor 135, security service system 110 may need to distribute a large amount of binary code to various endpoint devices 130 requiring a large amount of network resources. In addition, since security sensor 135 is tightly coupled with computing platform 140, an update to security sensor 135 may require a reboot of endpoint device 130 creating undesirable downtime for endpoint device 130. By providing compatibility information in configuration data 119, configuration service 118 of security service system 110 can provide a “zero touch update” to security sensor 135 reducing the need for a full update to security sensor 135 after endpoint device 130 installs updated computer platform 167.

The indication of compatibility in configuration data 119 between security sensor 135 and updated computing platform 167 may be a mapping of security sensor versions to computer platform versions or vice versa. For example, configuration data 119 may include a lookup table or hash map keyed off the AID for security sensor 135 or a version identifier associated with security sensor 135. When configuration manager 136 receives configuration data 119, it may use the lookup table or hash map to obtain a list of computing platform identifiers for which security sensor 135 is compatible. Alternatively, configuration data 119 may include a lookup table or hash map keyed off of a version identifier associated with computing platform 140/updated computer platform 167. In such instances, configuration manager 136 may use the lookup table or hash map to obtain a list of AIDs or version identifiers associated with security sensors that are compatible with computing platform 140/updated computer platform 167. Regardless, in either implementation, configuration manager can cause security sensor 135 to exit RFM if the indication of compatibility in configuration data 119 provides that security sensor 135 is compatible with the version of computing platform 140 currently executing on endpoint device 130.

Build analyzer 120 can compare a new version of the security sensor with its previous version by performing a compare between the binary objects resulting from a build. For example, build analyzer 120 may perform a diff operation on the binary or BLOBs of the two security sensor versions. If the diff shows there were no changes, or minimal changes, then build analyzer 120 can determine that the changes updated computer platform 167 provides to its respective computing platform did not affect the functionality of security sensor 135.

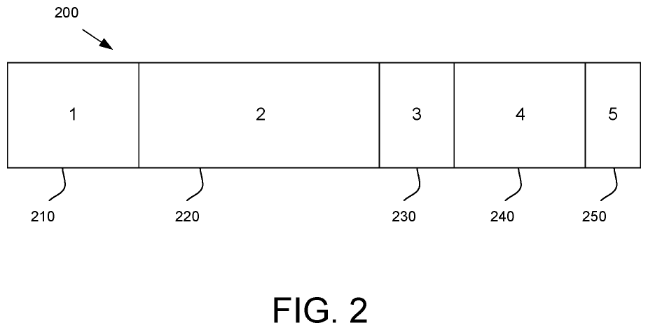

In some implementations, build analyzer 120 can reduce computing overhead by performing segmentation analysis on security sensor builds and only compare those segments related to interaction with computing platforms. FIG. 2 shows a pictorial representation 200 of a security sensor binary. Representation 200 shows that a security sensor may include five segments: first segment 210, second segment 220, third segment 230, fourth segment 240, and fifth segment 250. While representation 200 shows a security sensor build divided into five segments, representation 200 is merely example for explanation purposes and a security sensor build may include fewer or more segments.

Each segment of the security sensor build may correspond to a logical or functional aspect of the security sensor binary or BLOB. For example, first segment 210 may correspond to configuration manager 136, second segment 220 may correspond to event detectors 137, third segment 230 may correspond with enabling or disabling RFM, fourth segment 240 may correspond with reporting event data 138 to event processor 127, and fifth segment 250 may correspond with security sensor overhead. In such cases, second segment 220 and fourth segment 240 may be the only segments of the security sensor binary altered when the computing platform for which the security sensors are built has been updated.

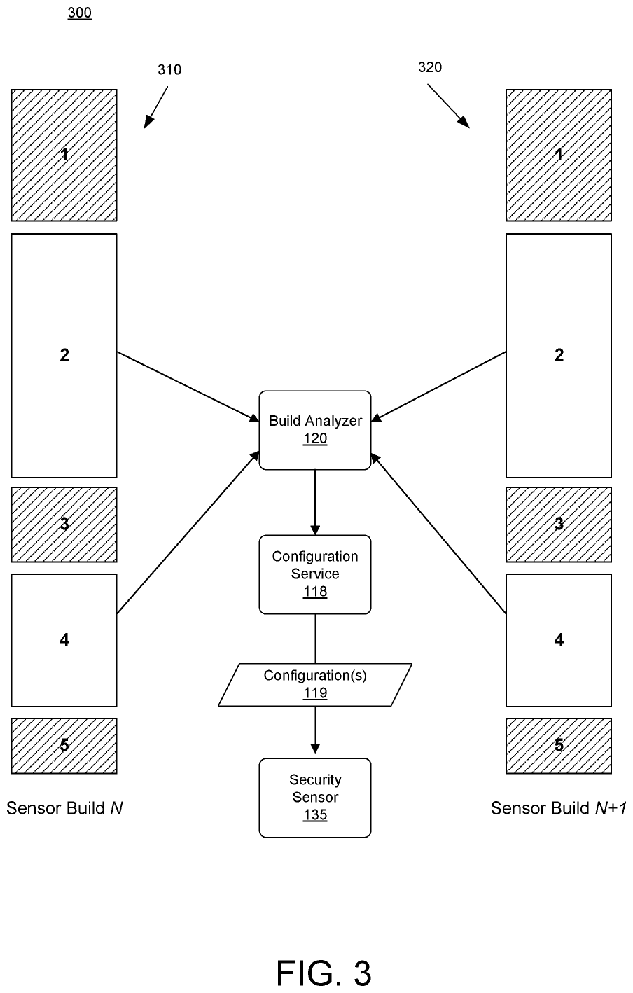

FIG. 3 shows, pictorially, an example segment-by-segment comparison process 300 performed by build analyzer 120 according to some embodiments. In the example process 300, build analyzer 120 is performing a comparison between two versions of a security sensor. Sensor builder 114 may have built sensor build N310 using a previous version of the computing environment and sensor builder 114 may have built sensor build N+1 320 for an updated version of the same computing environment. Using the example in the paragraph above, sensor build N 310 contains five segments where the second and fourth segments correspond to event detection functionality and event reporting functionality. Likewise, sensor build N+1 contains five segments where the second and fourth segments correspond to event detection functionality and event report reporting functionality.

To save processing time and computing resources, build analyzer 120 may only compare respective subsets of segments for each of sensor build N 310 and sensor build N+1 320 that are likely to have changed as a result of updates to the computing platform for which the security sensors were built. As shown in process 300, build analyzer 120 may compare segments two and four of sensor build N 310 and sensor build N+1, but may ignore segments one, three, and five when performing the comparison. If segments two and four of each build show no changes or few changes, build analyzer 120 may alert configuration service 118 to generate configuration parameters indicating that security sensor 135 need not be updated to operate with the previous version of the computing platform.

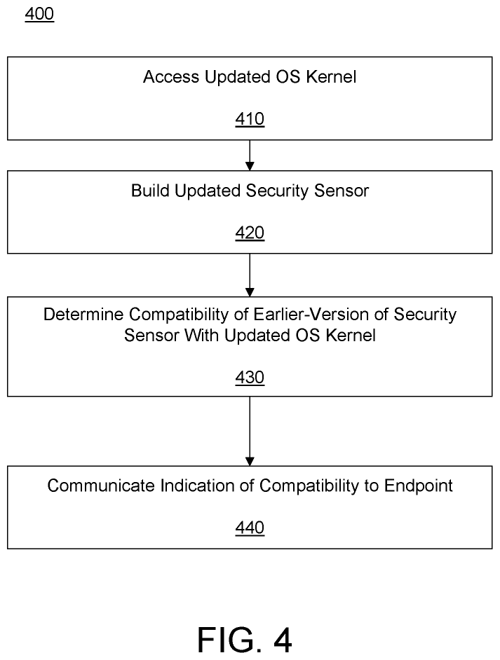

FIG. 4 shows a flowchart representing a first example zero-touch sensor update process 400. Process 400 can be performed by one or more components of a security service system implementing security sensors such as security service system 110. Process 400 is an example process for a zero-touch sensor update where a security sensor detects events related to an operating system kernel. Although the following discussion describes process 400 as being performed by a security service system, other computing systems that may include more or fewer components then security service system 110 can perform process 400 without departing from the spirit and scope of the present disclosure.

Process 400 begins at block 410 where a security service system accesses an update to an operating system kernel. The updated operating system kernel may include one or more updates or modifications to a previous version of the operating system kernel. In some implementations, the security service system may periodically poll or check a repository that makes available updates to the operating system kernels. In addition, or alternatively, the security service system may execute a program that interacts with a provider of operating system kernels whereby the provider of operating system kernels pushes updated operating system kernels to the security service system.

At block 420, the security service system may build an updated security sensor based at least in part on the updated operating system kernel. The updated security sensor may include one or more updates or modifications to a previous version of the security sensor. The security service system may have built the security sensor based at least in part on the previous version of the operating system kernel, i.e., the previous version of the security sensor may have been built to detect events related to the previous version of the operating system kernel and report those events to the security system service for the purpose of identifying poetically malicious behavior occurring on endpoint device 130.

At block 430, the security service system may determine the compatibility of the previous version of the security sensor with the updated operating system kernel. In some implementations, the security service system determines compatibility by comparing the previous version of the security sensor with the updated version of the security sensor. If the previous version of the security sensor (built for the previous version of the operating system kernel) is the same, or substantially the same, as the updated version of the security sensor (built for the updated version of the operating system kernel), then the changes between the previous version of the operating system kernel and the updated version of the operating system kernel had little to no effect on the functionality of the security sensor. The security service system may perform the comparison by performing a diff operation on the respective binaries of the previous version of the security sensor and the updated version of the security sensor. The diff operation may include comparing the entire binary of the previous version of the security sensor and the updated version of the security sensor. In some implementations, the security service system performs the diff operation by segmenting the respective binaries of the previous version of the security sensor and the updated version of the security sensor in performing a segment by segment comparison. The security service system may forgo comparing certain subsets of segments between the respective binaries of the previous version of the security sensor and the updated version of the security sensor consistent with the process described above with respect to FIGS. 2 and 3.

After the security service system determines the compatibility of the earlier version of the security sensor with the updated version of the operating system kernel, and may communicate an indication of that compatibility to an endpoint device executing the earlier version of the security sensor. The security service system may communicate the indication via a configuration file or configuration parameters that includes a mapping of security sensor versions to compatible operating system kernel versions. The configuration file can be a text-based file, serialized object, or a binary file. The security service system may communicate the indication of compatibility by providing a link or pointer to the endpoint device, and the security sensor running on the endpoint device may access configuration data using the link or pointer.

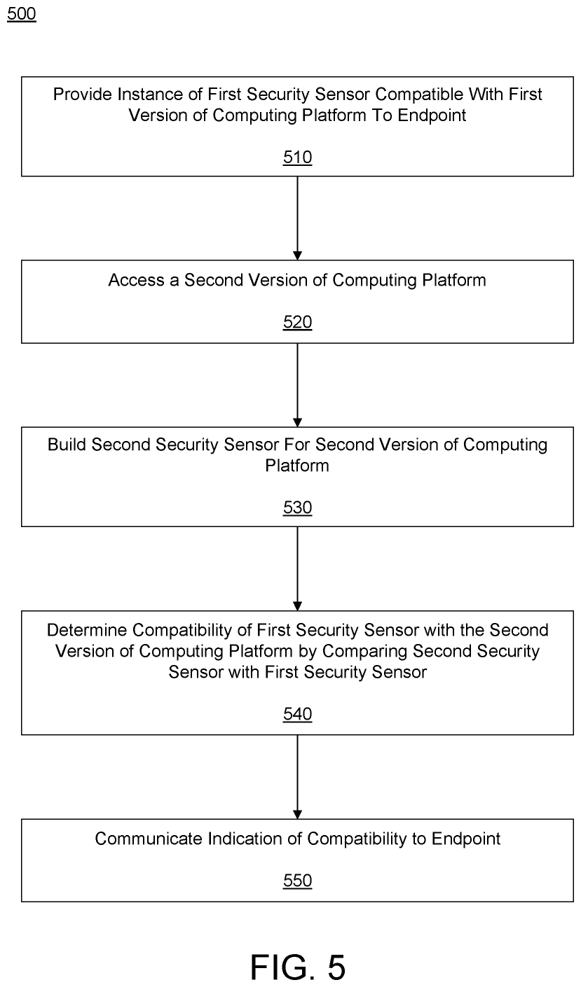

FIG. 5 shows a flowchart representing a second example zero-touch sensor update process 500. Process 500 can be performed by one or more components of a security service system implementing security sensors such as security service system 110. Process 500 is an example process for a zero-touch sensor update where a security sensor detects events related to an operating system kernel. Although the following discussion describes process 500 as being performed by a security service system, other computing systems that may include more or fewer components then security service system 110 can perform process 500 without departing from the spirit and scope of the present disclosure.

Process 500 begins at block 510 where a security service system provides an instance of a first security sensor to an endpoint device. The first security sensor can be compatible with a first version of the computing platform, and the endpoint device may operate using the first version of the computing platform. The first security sensor—consistent with disclosed embodiments—can be configured to detect events related to execution of the first version of the computing platform on the endpoint device with the purpose of potentially identifying malicious activity.

At block 520 the security service system accesses a second version of the computing platform. The second version of the computing platform may include one or more updates or modifications to the first version of the computing platform. In some implementations, the security service system may periodically poll or check a repository that makes available updates to the computing platform to determine whether updates have occurred. In addition, or alternatively, the security service system may execute a program that interacts with a provider of the computing platform whereby the provider of pushes updates to the security service system.

At block 530, the security service system may build a second security sensor based at least in part on the second version of the computing platform. The second security sensor may include one or more updates or modifications to the first security sensor.

At block 540, the security service system may determine the compatibility of the first security sensor with the second version of the computing platform. In some implementations, the security service system determines compatibility by comparing the first security sensor with the second security sensor. If the first security sensor (built for the first version of the computing platform) is the same, or substantially the same, as the second security sensor (built for the second version of the computing platform), then the changes between the first version of the computing platform and the second version of the computing platform had little to no effect on the functionality of the first security sensor. The security service system may perform the comparison by performing a diff operation on the respective binaries of the first security sensor and the second security sensor. The diff operation may include comparing the entire binary of the first security sensor and the second security sensor. In some implementations, the security service system performs the diff operation by segmenting the respective binaries of the first security sensor and the second security sensor and performing a segment by segment comparison. The security service system may forgo comparing certain subsets of segments between the respective binaries of the first security sensor and the second security sensor consistent with the process described above with respect to FIGS. 2 and 3.

After the security service system determines the compatibility of the first security sensor with the second version of the computing platform, it may communicate an indication of that compatibility to the endpoint devices executing the first security sensor. The security service system may communicate the indication via a configuration file or configuration parameters that includes a mapping of security sensor versions to compatible computing platform versions. The configuration file can be a text-based file, serialized object, or a binary file. The security service system may communicate the indication of compatibility by providing a link or pointer to the endpoint device, and the security sensor running on the endpoint device may access configuration data using the link or pointer.

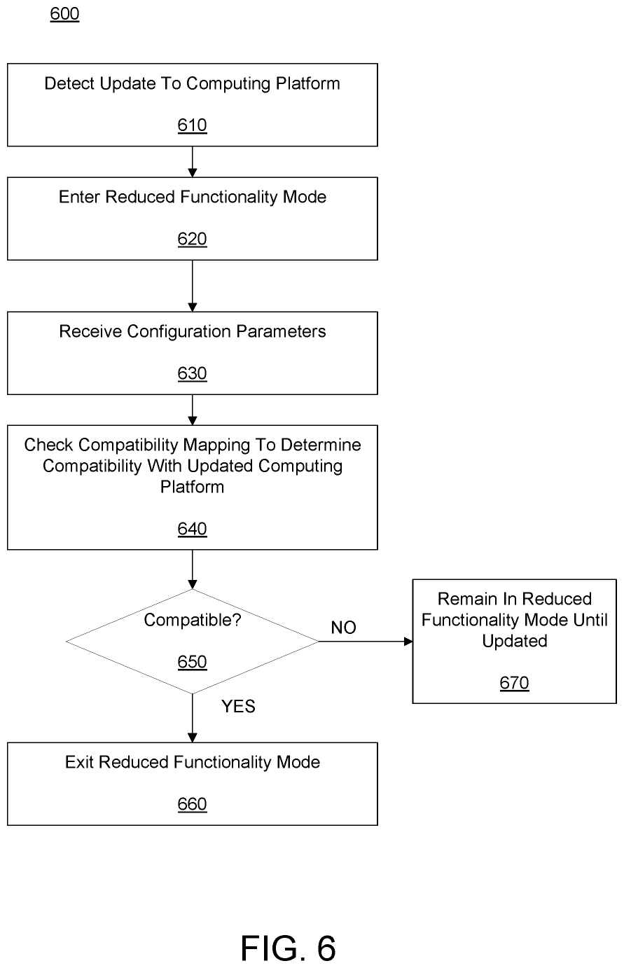

FIG. 6 shows a flowchart representing an example security sensor version reconciliation process 600. Process 600 can be performed by a security sensor (e.g., security sensor 135) installed and executing at an endpoint computing system (e.g., endpoint device 130). Although the following discussion describes process 600 as being performed by a configuration manager of security sensor (e.g., configuration manager 136), other components of a security sensor perform process 600 without departing from the spirit and scope of the present disclosure.

Process 600 begins at block 610 where the event detector of the security sensor detects an update to the computing platform of the endpoint device. After the event detector detects the update, the security sensor will enter a reduced functionality mode (RFM). In RFM, certain functionality may be disabled or reduced. For example, functions related to interacting with the computing platform may be disabled while maintenance functions, such as receiving updated configuration data, may be enabled.

At block 630, the configuration manager may receive configuration parameters from a security service system. The updated configuration parameters may include data related to the compatibility of security sensor versions and computing platform versions. At block 640, the configuration manager of the security sensor may check a compatibility mapping included in the receive configuration parameters to determine whether the security sensor is compatible with the version of the updated computing platform detected at block 610. For example, the compatibility mapping may include a hash map or lookup table keyed by the version number of the security sensor where the values returned by the hash map or lookup table include version numbers or identification of computing platforms that are compatible with the security sensor version number.

If the compatibility mapping indicates that the security sensor is compatible (block 650: YES), then the security sensor will exit RFM at block 660 thereby enabling event detection for the updated computer platform. If the compatibility mapping indicates that the security sensor is not compatible with the updated computing platform (block 650: NO), the security sensor will perform block 670 of process 600 and remain in RFM until the security sensor is updated. In some implementations, the security sensor will continue to monitor for additional configuration parameters and if additional configuration parameters are received, security sensor may perform blocks 630, 640 and 650 of process 600 again.

FIG. 7 depicts an example system architecture for endpoint device 130. Endpoint device 130 can be one or more computing devices, such as a work station, a personal computer (PC), a laptop computer, a tablet computer, a personal digital assistant (PDA), a cellular phone, a media center, an embedded system, a server or server farm, multiple distributed server farms, a mainframe, or any other type of computing device. As shown in FIG. 7, endpoint device 130 can include processor(s) 702, memory 704, communication interface(s) 706, output devices 708, input devices 710, and/or a drive unit 712 including a machine readable medium 714.

In various examples, processor(s) 702 can be a central processing unit (CPU), a graphics processing unit (GPU), or both CPU and GPU, or any other type of processing unit. Each of the one or more processor(s) 702 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. Processor(s) 702 may also be responsible for executing drivers and other computer-executable instructions for applications, routines, or processes stored in the memory 704, which can be associated with common types of volatile (RAM) and/or nonvolatile (ROM) memory.

In various examples, memory 704 can include system memory, which may be volatile (such as RAM), non-volatile (such as ROM, flash memory, etc.) or some combination of the two. Memory 704 can further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information and which can be accessed by endpoint device 130. Any such non-transitory computer-readable media may be part of endpoint device 130.

Memory 704 can store data, including computer-executable instructions, for a security sensor 135 as described herein. Memory 704 can further store event data 122, configurations 132, and/or other data being processed and/or used by one or more components of the security sensor 135. The memory 704 can also store any other modules and data 716 that can be utilized by the endpoint device 130 to perform or enable performing any action taken by the endpoint device 130. For example, the modules and data can a platform, operating system, and/or applications, as well as data utilized by the platform, operating system, and/or applications.

Communication interfaces 706 can link endpoint device 130 to other elements through wired or wireless connections. For example, communication interfaces 706 can be wired networking interfaces, such as Ethernet interfaces or other wired data connections, or wireless data interfaces that include transceivers, modems, interfaces, antennas, and/or other components, such as a Wi-Fi interface. Communication interfaces 706 can include one or more modems, receivers, transmitters, antennas, interfaces, error correction units, symbol coders and decoders, processors, chips, application specific integrated circuits (ASICs), programmable circuit (e.g., field programmable gate arrays), software components, firmware components, and/or other components that enable endpoint device 130 to send and/or receive data, for example to security service system 110.

Output devices 708 can include one or more types of output devices, such as speakers or a display, such as a liquid crystal display. Output devices 708 can also include ports for one or more peripheral devices, such as headphones, peripheral speakers, and/or a peripheral display. In some examples, a display can be a touch-sensitive display screen, which can also act as an input device 710.

Input devices 710 can include one or more types of input devices, such as a microphone, a keyboard or keypad, and/or a touch-sensitive display, such as the touch-sensitive display screen described above.

The drive unit 712 and machine readable medium 714 can store one or more sets of computer-executable instructions, such as software or firmware, that embodies any one or more of the methodologies or functions described herein. The computer-executable instructions can also reside, completely or at least partially, within processor(s) 702, memory 704, and/or communication interface(s) 706 during execution thereof by endpoint device 130. Processor(s) 702 and memory 704 can also constitute machine readable media 714.

FIG. 8 depicts an example system architecture for one or more cloud computing elements 800 of security service system 110. Elements of security service system 110 described above can be distributed among, and be implemented by, one or more cloud computing elements 800 such as servers, servers, server farms, distributed server farms, hardware computing elements, virtualized computing elements, and/or other network computing elements.

A cloud computing element 800 can have system memory 802 that stores data associated with one or more cloud elements of the security service system 110, including one or more instances of sensor build repository 112, sensor builder 114, configuration service 118, build analyzer 120, platform fetcher 125, and event processor 127. Although in some examples a particular cloud computing element 800 may store data for a single cloud element, or even portions of a cloud element, of the security service system 110, in other examples a particular cloud computing element 800 may store data for multiple cloud elements of the security service system 110, or separate virtualized instances of one or more cloud elements. The system memory 802 can also store other modules and data 804, which can be utilized by the cloud computing element 800 to perform or enable performing any action taken by the cloud computing element 800. The other modules and data 804 can include a platform, operating system, or applications, and/or data utilized by the platform, operating system, or applications.

In various examples, system memory 802 can be volatile (such as RAM), non-volatile (such as ROM, flash memory, etc.), or some combination of the two. Example system memory 802 can include one or more of RAM, ROM, EEPROM, a Flash Memory, a hard drive, a memory card, an optical storage, a magnetic cassette, a magnetic tape, a magnetic disk storage or another magnetic storage devices, or any other medium.

The one or more cloud computing elements 800 can also include processor(s) 806, removable storage 808, non-removable storage 810, input device(s) 812, output device(s) 814, and/or communication connections 816 for communicating with other network elements 818, such as endpoint device 130 and other cloud computing elements 800.

In some embodiments, the processor(s) 806 can be a central processing unit (CPU), a graphics processing unit (GPU), both CPU and GPU, or other processing unit or component known in the art.

The one or more cloud computing elements 800 can also include additional data storage devices (removable and/or non-removable) such as, for example, magnetic disks, optical disks, or tape. Such additional storage is illustrated in FIG. 8 by removable storage 808 and non-removable storage 810. Computer storage media may include volatile and nonvolatile, removable and non-removable media implemented in any method or technology for storage of information, such as computer readable instructions, data structures, program modules, or other data. System memory 802, removable storage 808 and non-removable storage 810 are all examples of computer-readable storage media. Computer-readable storage media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by the one or more cloud computing elements 800. Any such computer-readable storage media can be part of the one or more cloud computing elements 800. In various examples, any or all of system memory 802, removable storage 808, and non-removable storage 810, store computer-executable instructions which, when executed, implement some or all of the herein-described operations of the security service system 110 and its cloud computing elements 800.

In some examples, the one or more cloud computing elements 800 can also have input device(s) 812, such as a keyboard, a mouse, a touch-sensitive display, voice input device, etc., and/or output device(s) 814 such as a display, speakers, a printer, etc. These devices are well known in the art and need not be discussed at length here.

The one or more cloud computing elements 800 can also contain communication connections 816 that allow the one or more cloud computing elements 800 to communicate with other network elements 818. For example, the communication connections 816 can allow the security service system 110 to send new configurations 132 to security sensor 135 on endpoint device 130, and/or receive event data 122 from such security sensor 135 on endpoint device 130.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method comprising:
accessing an updated operating system kernel, the updated operating system kernel including a modification to an earlier-version operating system kernel;
building an updated security sensor based at least in part on the updated operating system kernel;
determining compatibility of the updated security sensor with the earlier-version operating system kernel, the determining based at least in part on comparing the updated security sensor with an earlier-version security sensor built for the earlier-version operating system kernel; and
communicating, to an end-point computing device, an indication of compatibility of the earlier-version security sensor with the updated operating system kernel.

2. The computer-implemented method of claim 1 wherein comparing the updated security sensor with the earlier-version security sensor comprises comparing a BLOB (binary large object) of the updated security sensor with a BLOB of the earlier-version security sensor.

3. The computer-implemented method of claim 1 wherein comparing the updated security sensor with the earlier-version security sensor comprises:
segmenting a binary of the updated security sensor;
segmenting a binary of the earlier-version security sensor; and
comparing segments of the binary of the updated security sensor with corresponding segments of the binary of the earlier-version security sensor.

4. The computer-implemented method of claim 3 wherein comparing segments of the binary of the updated security sensor with corresponding segments of the binary of the earlier-version security sensor includes forgoing comparing a subset of the segments of the binary of the updated security sensor to a corresponding subset of segments of the binary of the earlier-version security sensor.

5. The computer-implemented method of claim 1 wherein the indication of compatibility of the earlier-version security sensor with the updated operating system kernel is communicated via a properties file.

6. The computer-implemented method of claim 5 wherein the properties file comprises a mapping of the updated operating system kernel with a plurality of deployed security sensors indicating that the plurality of deployed security sensors are compatible with the updated operating system kernel.

7. The computer-implemented method of claim 1 wherein the indication of compatibility is configured to cause deployed instances of the earlier-version security sensor to exit a reduced functionality mode.

8. A system comprising:
one or more processors; and
a non-transitory computer readable medium storing executable instructions that when executed by the one or more processors cause the one or more processors to perform operations comprising:
accessing an updated operating system kernel, the updated operating system kernel including a modification to an earlier-version operating system kernel;
building an updated security sensor based at least in part on the updated operating system kernel;
determining, based on comparing the updated security sensor with an earlier-version security sensor built for the earlier-version operating system kernel, compatibility of the updated security sensor with the earlier-version operating system kernel; and
communicating, to an end-point computing device, an indication of compatibility of the earlier-version security sensor with the updated operating system kernel.

9. The system of claim 8 wherein comparing the updated security sensor with the earlier-version security sensor comprises comparing a BLOB (binary large object) of the updated security sensor with a BLOB of the earlier-version security sensor.

10. The system of claim 8 wherein comparing the updated security sensor with the earlier-version security sensor comprises:
segmenting a binary of the updated security sensor;
segmenting a binary of the earlier-version security sensor; and
comparing segments of the binary of the updated security sensor with corresponding segments of the binary of the earlier-version security sensor.

11. The system of claim 10 wherein comparing segments of the binary of the updated security sensor with corresponding segments of the binary of the earlier-version security sensor includes forgoing comparing a subset of the segments of the binary of the updated security sensor to a corresponding subset of segments of the binary of the earlier-version security sensor.

12. The system of claim 8 wherein the compatibility of the updated security sensor with the earlier-version operating system kernel is communicated via a properties file.

13. The system of claim 12 wherein the properties file comprises a mapping of the updated operating system kernel with a plurality of deployed security sensors indicating that the plurality of deployed security sensors are compatible with the updated operating system kernel.

14. The system of claim 8 wherein the indication of compatibility is configured to cause deployed instances of the earlier-version security sensor to exit a reduced functionality mode.

15. A computer-implemented method comprising:
providing, to an end-point computer system running a first version of a computing platform, an instance of a first security sensor compatible with the first version of the computing platform, the first security sensor configured to enter a reduced functionality mode based at least in part on the first security sensor detecting a modification to the first version of the computing platform;
accessing a second version of the computing platform, the second version of the computing platform including a modification to the first version of the computing platform;
building a second security sensor based at least in part on the second version of the computing platform;
determining compatibility of the first security sensor with the second version of the computing platform by comparing the second security sensor with the first security sensor; and
communicating, to the end-point computing device, an indication that the first security sensor is compatible the second version of the computing platform.

16. The computer-implemented method of claim 15, wherein the first security sensor is configured to exit the reduced functionality mode when the modification to the first version of the computing platform includes the second version of the computing platform.

17. The computer-implemented method of claim 15 wherein comparing the second security sensor with the first security sensor comprises comparing a BLOB (binary large object) of the second security sensor with a BLOB of the first security sensor.

18. The computer-implemented method of claim 15 wherein comparing the second security sensor with the first security sensor comprises:
segmenting a binary of the second security sensor;
segmenting a binary of the first security sensor; and
comparing segments of the binary of the second security sensor with corresponding segments of the binary of the first security sensor.

19. The computer-implemented method of claim 16 wherein comparing segments of the binary of the second security sensor with corresponding segments of the binary of the first security sensor includes forgoing comparing a subset of the segments of the binary of the second security sensor to a corresponding subset of segments of the binary of the second security sensor.

20. The computer-implemented method of claim 1 wherein the indication of compatibility of the first security sensor with the second computing platform is communicated via a properties file.
